(19) United States
(12) Patent Application Publication
(10) Pub. No.: US 2025/0081970 A1
(43) Pub. Date: Mar. 13, 2025

(54) POLYMER NANOCOMPOSITES WITH SUB 5NM NANOPARTICLES FOR IMPROVED ANTIMICROBIAL EFFECTIVENESS

(71) Applicant: SABANCI UNIVERSITESI NANOTEKNOLOJI ARASTIRMA VE UYGULAMA MERKEZI, Istanbul (TR)

(72) Inventors: Mustafa Kemal BAYAZIT, Istanbul (TR); Meral YUCE, Istanbul (TR)

(73) Assignee: SABANCI UNIVERSITESI NANOTEKNOLOJI ARASTIRMA VE UYGULAMA MERKEZI, Istanbul (TR)

(21) Appl. No.: 18/292,950

(22) PCT Filed: May 23, 2022
(86) PCT No.: PCT/TR2022/050465

§ 371 Date: Jan. 29, 2024

(30) Foreign Application Priority Data
Jul. 28, 2021 (TR) 2021/011988

(51) Int. Cl. A01N 59/16; A01N 25/10; A01N 25/28; A61P 1/00

(52) U.S. Cl. CPC A01N 59/16; A01N 25/10; A01N 25/28; A61P 1/00

(57) ABSTRACT

A method for producing a metal nanoparticle-polymer composite that includes uniformly shaped metal nanoparticles uniformly dispersed in a polymer matrix is provided. The method may be used to produce a silver nanoparticle-polymer composite that includes nanoparticles having a size smaller than 5 nm by a double-syringe microwave-flow system.

### CROSS REFERENCE TO THE RELATED APPLICATION

This application is the national phase entry of International Application No. PCT/TR2022/050465, filed on May 23, 2022, which is based upon and claims priority to TR2021/011988, filed on Jul. 28, 2021, in the Republic of Turkey, the entire contents of which are incorporated herein by reference.

### TECHNICAL FIELD

The present invention relates to a highly efficient, sustainable, fast, scalable and cost-effective method for producing the antimicrobial polymer nanocomposites (PNCs) containing smaller than 5 nm nanoparticles (NPs). The invention further relates to the testing antimicrobial effectiveness of the PNCs by using three different bacteria outperform their counterparts containing large NPs. The present invention not only proposes a cost-effective and up-scalable microwave-assisted flow synthesis route for high-quality PNCs but also intends to fine-tune material properties for various application areas, including healthcare, textile industry, paper industry, and surface coating materials.

### BACKGROUND

Previous techniques such as mechanical mixing of NPs with polymers in a solvent and in-situ batch synthesis of NPs in the presence of a polymer have been used to maintain distribution of NPs [4]. However, these techniques have failed mostly for large scale productions due to particle aggregation and poor dispersibility. Furthermore, particle aggregation results in more raw material consumption to achieve the target composite performance and irreproducible results. There is still not a sustainable, fast, scalable and cost-effective manufacturing process controlling homogeneous distribution and interaction of NPs in a polymer matrix, although some matrix composites (MCs) having good NP distributions have been produced in laboratory scales.

In the prior art, the microwave-induced preparation of pure metal [1] and metal oxide [2] nanoparticles in a flow reactor system was adapted to prepare the PNCs. Besides, the effect of microwave power, flow rate, and precursor concentration on the size and shape of nanoparticles and their distribution has been discussed. However, the known system [3] was only proven for the synthesis of pure NPs in an aqueous solution using a single syringe (FIG. 1a) and the use of a single syringe system is extremely limited while producing NPs. In that system, using high dielectric loss solvents (e.g. water) ensures strong microwave absorption by the solvent. In other words, the applied microwave irradiation is mainly consumed by the solvent and it is used as a heating source. As a result, fast and hard-to-control temperature changes which is likely to have a considerable effect on the size distribution of NPs are unavoidable in the flow reactor zone. Furthermore, a single syringe pump has been used to deliver an aqueous precursor solution to the reaction zone. In many cases, preparing a mixture of a reducing agent and metal salt precursor (e.g. sodium citrate and auric acid) at room temperature may initiate NP formation before entering the reaction zone, resulting in an inhomogeneity in particle size and the flow regime. These pre-formed seeds may lead to the formation of bigger particles throughout the reactor zone and alter the homogeneity of particle size and the flow regime. Furthermore, even at room temperature, some organic solvents act as reducing agents and start NP nucleation. For example, silver NPs can be prepared in N,N-dimethylformamide at room temperature.

### SUMMARY OF THE INVENTION

The present invention relates to a method for producing a metal nanoparticle-polymer composite comprising uniformly shaped metal nanoparticles uniformly dispersed in a polymer matrix.

It is an object of the present invention is to solve the issue of agglomeration and poor dispersibility of NPs in a polymer matrix.

Another object of the present invention is to design an in-house developed microwave-flow manufacturing system which can be used for continuous and reproducible production of highly effective advanced antimicrobial PNCs. In the initial phase, a microwave-powered fluidic reactor is to be designed by combining two of the most lucrative phenomena: microwave heating and flow conditions, followed by the optimization of this technology by experimental and computational means. This technology is subsequently used for the fabrication and characterization of a range of composites with polymer matrices (polyamides, polyesters, cellulose acetate, and polyurethane) and nano-fillers (e.g. Ag). However, the technology is not limited by the abovementioned polymers and the nanofiller. It can be expanded to any polymer and metal salt family that are soluble in a suitable aqueous/organic solvent.

In the present invention, a double-syringe manufacturing system is constructed to ensure the NPs were only produced in the reactor under microwave-flow conditions (FIG. 1b).

This new technology combines microwave irradiation (MI) with fluidic systems for the high throughput synthesis of composite materials in the solution phase. Proposed technology achieves this via an up-scalable manufacturing rig coupling energy efficient microwave heating with continuous fluidic reactor technology (FIG. 2).

The advantages, including novelty/innovative aspects of proposed invention as well as superiority to prior art is summarized as follows:
i. There is no prior art describing the continuous preparation of highly antimicrobial PNCs having homogeneously distributed NPs of <5 nm in size.
ii. The prior art (single syringe microwave-flow system) has never been used for the preparation of multicomponent systems such as PNCs. It was only limited by pure NP formation in aqueous conditions.
iii. A double-syringe microwave-flow system was for the first time shown to be effective for continuous PNC preparation in organic solvents.
iv. The present invention can prepare PNCs with/without using a reducing agent.
v. The present invention can prepare PNCs in a single solvent or a binary solvent.
vi. The PNCs having small NPs (<5 nm) show high antimicrobial effectiveness compared to their counterparts, containing large particles, prepared by traditional methods.
vii. This process benefits from polymer functional groups as nucleation sites/nucleating agents and stabilizing reagents to fine-controlling of NP size and its distribution in a polymer/organic solvent system.
viii. This process uses low dielectric loss solvents (e.g. DMF, NMP, DMSO) to finely control the temperature variations and carry out the NP formation at low temperatures.
ix. This process enables the real-time generation of nuclei on the activated polymer functional groups and stabilizes the formed nuclei/seeds/NPs throughout the process. By this way, homogeneously distributed small NPs are fabricated in polymer matrix.
x. This process uses the synergistic effect of microwave/solvent/polymer surface groups as reducing agents and benefits from the triple-reducing agent effect. However, other reducing agents can also be used in the process if required.
xi. This process is able to prepare in-situ polymer composites at low temperatures (˜50° C.) and this improves the energy utilisation efficiency to decrease energy demand in composite preparation compared to conventional heating (CH) methods. On the other hand, the system is also suitable for high temperature conditions (˜300° C.).
xii. This technology benefits from fluidic systems, including small channels (<1 cm), benefit from large surface-to-volume ratio, provide rapid mixing, controllable mass and heat transfer under continuous flow condition.
xiii. This technology can be readily scaled up by numbering up the fluidic reactors rather than conventionally enlarging the reactor size, for high throughput, continuous matrix composite engineering.
xiv. This methodology is not limited to composite synthesis; it could be coupled with aerosol- and/or spray-assisted systems to produce films of produced composites.

### BRIEF DESCRIPTION OF THE DRAWINGS

FIG. 1a A single syringe microwave-flow system for NP synthesis (Prior art)

FIG. 1b A double-syringe microwave-flow system for PNC preparation (invention).

FIG. 2 Continuous microwave-fluidic system for the large scale manufacturing of PNC

FIG. 3 The microwave energy absorbing characteristic of a) water, b) DMF and c) NMP at 30, 40, 50, 60 and 70 W microwave powers.

FIG. 4 a) The UV-vis spectra of pure NMP and polyamide in NMP, b) The microwave energy absorbing characteristic of NMP at 80, 90, 100 and 110 W microwave powers.

FIG. 5 The UV-vis spectra of AgNO₃ solution in NMP after passing through the flow reactor (Reactor volume=8 mL, Flow rate=1mL/min) at 80, 90, 100 and 110 W microwave powers.

FIG. 6 The UV-vis spectra of composite 1-4 in NMP.

FIG. 7 The SEM images of the as-received a) PA, b) the Composite 1 and c) the Composite 2

FIG. 8 The SEM images of the a) Composite 3 and the Composite 4, and the size distribution of the produced Ag NPs (c, d).

FIG. 9 UV-Vis spectra of AgNP/PA composites prepared by using PA concentration of a) 0.8 (2×PA), b) 0.4 (1×PA), and c) 0.2 gr (1/2×PA) in 100 mL formic acid. A glance at this figure revealed that increasing the amount of PA in formic acid led to a blue-shift in [symbol] max of synthesized AgNPs.

FIG. 10 HRTEM image of AgNPs/PA composite (left) and the PSD of AgNPs. It shows an average AgNP size of 3.74±0.50 nm in the PA matrix.

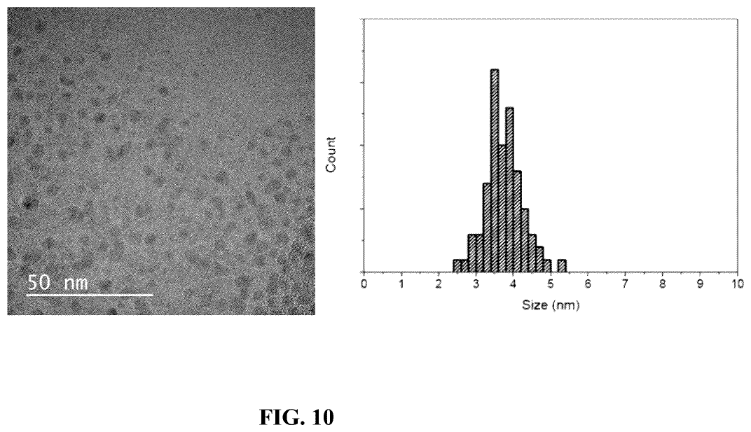

FIG. 11 DLS data based on particle radius. The first power of the particle radius is used to calculate the number-based graph. Small particles can be tracked using the number-based DLS. DLS results showed that more than 99 percent of AgNPs had a hydrodynamic size of ˜2 nm.

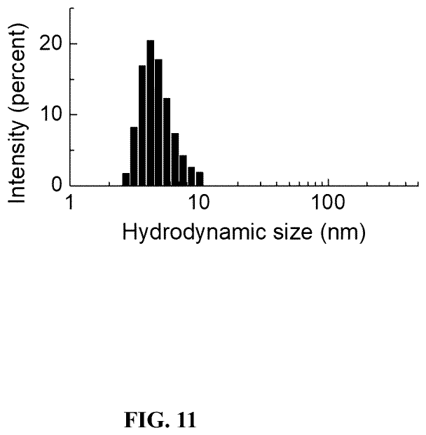

FIG. 12 HRTEM image of AgNPs/PCL composite (left) and the PSD of AgNPs. Image shows a homogenous distribution of AgNPs with average size of 1.78±0.32 nm in PCL matrix.

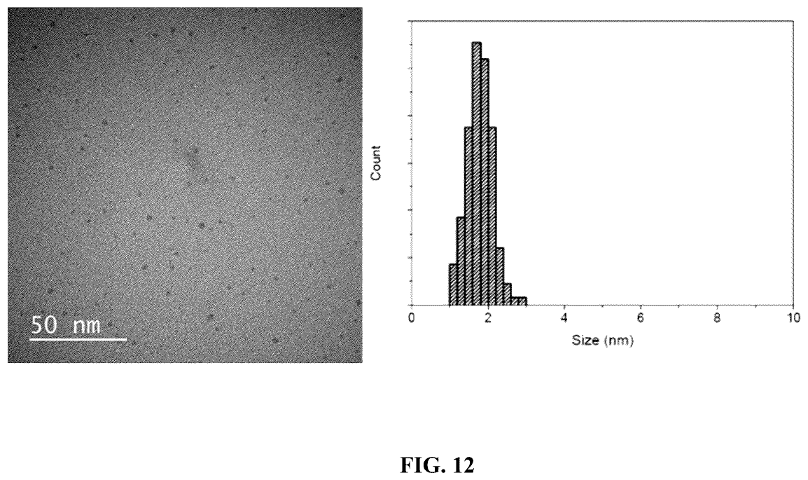

FIG. 13 Colony forming units (CFU) of E. coli, P. aeruginosa, and S. aureus after exposure to a) glass slide (reference) and b) Ag/PA nanocomposite film.

### DEFINITIONS OF THE COMPONENTS/PARTS/PIECES THAT MAKE UP THE INVENTION

1—Syringe pump
2—Syringe
3—Microwave heating source
4—Coiled-Flow reactor
5—Temperature controller
6—Cooler
7—Three-way connector
8—Two-way valves
9—Four-way connector
10—Pressure regulator
11—Pressure equalizing bridge
12—Waste container
13—Product container
14—Bubbler
15—Pressurized gas source
16—Product outlet valve
17—Large precursor container
18—Peristaltic pump
19—Waste collection line
20—Large product collection container

### DETAILED DESCRIPTION OF EMBODIMENTS

The present invention relates to a highly efficient, sustainable, fast, scalable and cost-effective manufacturing process for the antimicrobial polymer nanocomposites (PNCs) containing smaller than 5 nm nanoparticles (NPs) by using a double-syringe microwave-flow system. After preparation of these PNCs, antimicrobial activities of PNCs are tested by using three different bacteria outperform their counterparts containing large NPs.

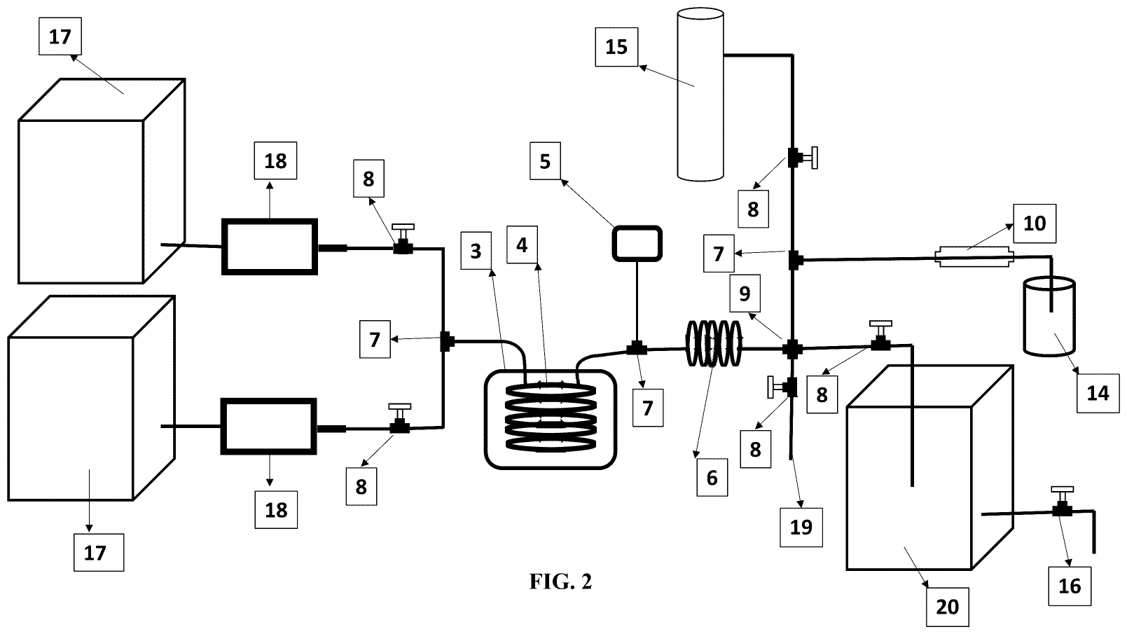

The polymer composite fabrication process described in present invention overcomes issue of agglomeration and poor dispersibility of NPs in a polymer matrix by elegantly coupling the superior surface functionality of commercial polymers that potentially serves as a stabilizing agent, nucleation site, and nucleating agent with sustainable microwave heating and flow reactor technology. In short, this process describes a fast and sustainable in-situ synthetic approach to fabricating polymer-nanoparticle composites having homogeneous nanoparticle distribution under flow conditions and microwave heating. The proposed process achieves this via an up-scalable fabrication rig shown in FIG. 2.

With some exceptions, organic polymers are generally soluble in organic solvents having suitable functional groups that can strongly interact with the polymer functional groups. N,N-dimethylformamide (DMF), N,N-dimethylyacetamide (DMAc) and N-Methyl-2-pyrrolidone (NMP) are low dielectric loss solvents and are known to interact microwave radiation less compared to high dielectric loss water. On the other hand, they are very strong solvents to dissolve organic polymers including polyamides, polyurethanes, cellulose acetates and polyesters and their derivatives. Thus, the superior properties of these solvents make them a suitable candidate to work under microwave conditions at low temperatures. In addition, these solvents can serve as reducing agents while synthesizing metal NPs, probably due to their functional groups. Similar functional groups are also present on the above-mentioned functional polymers and their derivatives and one can expect that the functionalities on the polymers can potentially serve as a stabilizing agent, nucleation site, and nucleating agent. However, the activation of these functional sites using a suitable energy source is required to induce particle nucleation and stabilization.

In this context, microwave energy appears as a non-destructive energy source. In a flow reactor system, the fluid temperature gradually changes from room temperature to higher temperatures when microwave irradiation is applied. The temperature change is very rapid when an aqueous solution or high dielectric loss solvents are used under microwave conditions. The rapid temperature variations inside the flow reactor can cause uncontrollable particle growth throughout the reactor. Temperature variations can be small when low dielectric loss solvents are used. In principle, using a low dielectric loss solvent (e.g. DMF, NMP etc.) can keep the temperature increase and its variation low throughout the reactor. By doing so, the excess of applied microwave irradiation can be conserved and utilized for another purpose (e.g. activation of polymer functional groups). Besides, microwave irradiation is known to be a powerful reducing agent to prepare metal NPs. In this way, the remaining microwave irradiation can be used for reducing metal salt precursors into metal NPs. All in all, a triple-reducing agent effect (microwave irradiation, solvent, and polymer functional groups) is utilized while fabricating NPs in the presence of polymers dissolved in organic solvents under microwave conditions. In this system, the most important role of polymer functional groups is to serve as nucleation sites that facilitate the fast and simultaneous generation of a lot of nuclei and the stabilization of them throughout the reactor. This enables the controlled growth of NPs that are strongly bound to functional moieties. This type of interaction results in fabricating small and homogeneously distributed NPs in the polymer matrix which is not possible otherwise.

In this invention, metal salt precursor can be inorganic/organic silver (AgNO₃, CH₃COOAg), copper (Cu(NO₃)₂, CuCO₂CH₃, Cu(CO₂CH₃)₂), zinc (Zn(NO₃)₂, Zn(CH₃COO)₂) or iron (Fe(NO₃)₃, Fe(CO₂CH₃)₂).

Furthermore, the use of dual syringes and T-junction brings up an additional control mechanism over the fine-tuning of precursor concentration and prevents any likely particle formation prior to entering the reaction zone. By doing so, the system allows us to fine-tuning of the metal precursor amount in unit volume and to eliminate the undesired seed/nuclei formation that can cause uneven particle distribution inside the flow reactor.

Finally, the concept of utilizing the superior polymer surface functionalities as nucleation sites/nucleating agents to control NP size and its distribution in a polymer/organic solvent system and to continuously fabricate polymer composites under microwave-fluidic conditions is a novel process and has never been tried before.

### A Double-Syringe Microwave-Flow System

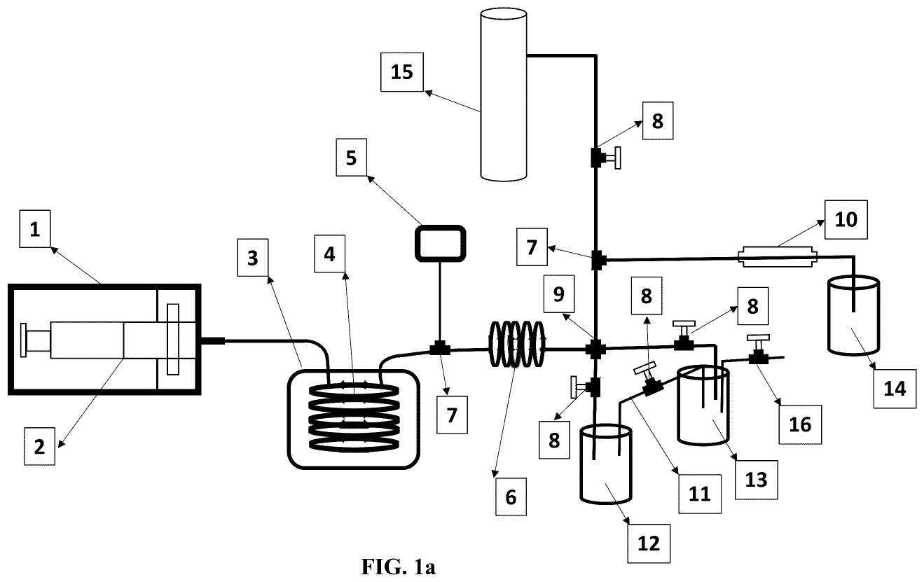

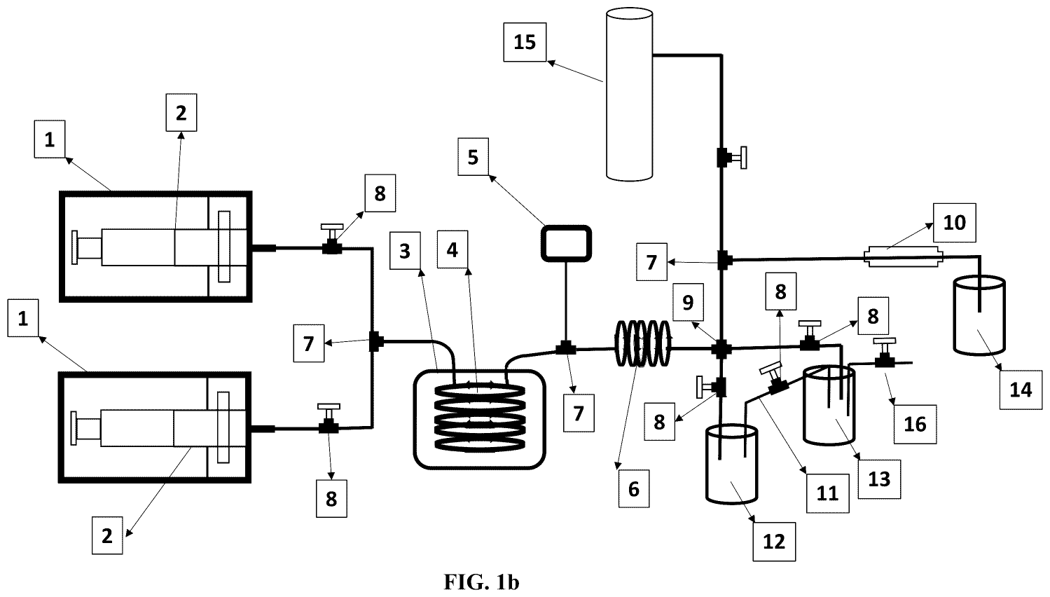

A double-syringe microwave-flow system as shown in FIG. 1b is used as continuous flow reactor for preparation of antimicrobial PNCs having small NPs (<5 nm). A double-syringe microwave-flow system for PNC preparation comprises two syringe pumps (1), two syringes (2), a microwave heating source (3), a coiled-flow reactor (4), a temperature controller (5), a cooler (6), at least one three-way connector (7), at least one two-way valves (8), a four-way connector (9), a pressure regulator (10), a pressure equalizing bridge (11), a waste container (12), a product container (13), a bubbler (14), pressurized gas source (15) and a product outlet valve (16).

More specifically, the microwave-flow manufacturing system used in the experiments consists of a flow reactor (8 mL) made of ⅛ in. o.d. (˜0.32 cm) Teflon tubing, a commercially available single-mode microwave system (2.45 GHz), syringe pumps (60 mL), a thermocouple temperature probe positioned ˜5 cm away from the exit of microwave heating zone, a sample and waste collection unit with backpressure regulator (20 psi) to control reactor pressure, and an ice-bath placed between the end of the flow reactor and sample collection unit.

The system given in FIG. 1b can be modified for the large scale production of PNCs. In the modified system shown in FIG. 2, the system components, 3 to 16, are not changed but four new components (17 to 20) are added. These are large precursor containers (17), peristaltic pumps (18), a waste collection line (19), and a large product collection container (20). The size and capacity of both containers (17 and 20) and pumps (18) may vary (from kg to tonnes) depending on the production conditions.

### Producing Method of Polymer Nanocomposites

A method for production of the antimicrobial polymer nanocomposite structure comprises the steps of:
a) Dissolving of polymer in any suitable aqueous or organic solvent at room temperature,
b) Preparing a solution of a metal salt precursor by dissolving it in a solvent that does not act as a reducing agent at ambient condition and miscible with the polymer's solvent,
c) Transferring the precursor solutions prepared in step a and b into coiled-flow reactor (4) by two syringes (2) finely controlled by two syringe pumps (1) or by two peristaltic pumps (18) to obtain pre-defined reaction concentrations for scalable productions or by single syringe if no reducing agent is used at room temperature in the solvent by closing one of the valves (8),
d) Before reaching coiled-flow reactor (4), pre-mixing of precursor solutions in three-way connector (7) for homogeneous mixture formation and fine-tuning of precursor concentration,
e) Dispensing of precursor solutions to the coiled-flow reactor (4) at known concentrations and flow rates under constant microwave power,
f) Producing homogeneously distributed NPs with <5 nm in size in the polymer matrix under the controlled pressure provided by a pressure regulator (10) and pressurized gas source (15).

In a typical PC manufacturing, the syringes (2) filled with the precursor solutions prepared in a suitable solvent are used to transfer the fluid into the coiled-flow reactor (4). A syringe pump (1) is used to control the flow rate of the fluid at sub-μLs range. If there is no nanoparticle formation at room temperature in the solvent used the double-syringe system can be operated in single-syringe mode by closing one of the valves (8). If there is nanoparticle formation at room temperature in the solvent used the double-syringe system. Under these circumstances, the precursor of nanoparticles is prepared in a solvent that is miscible with the polymer's solvent but is not acting as a reducing agent at room temperature. Using the double-syringe mode with controlled flow rate function provides fine-tuning over the concentration of both polymer and metal precursor and as a result of fine-tuning the size and the distribution of produced nanoparticles can be finely manipulated. In addition, the double-syringe mode enables the homogeneous mixing of two different fluid phases inside the three-way connectors (7). After controlled dispensing of the fluid to the coiled-flow reactor, it travels at a constant flow rate that is regulated by the back-pressure regulator (10) and the pressurized gas source (15). In addition, a constant microwave power generated by the microwave heating source (3) having varying power options (1 to 300 W) is exerted on the reaction fluid throughout the microwave zone. Temperature of the reaction fluid after microwave heating is recorded using the temperature controller (5). An optional cooler (6) is used for fast quenching of nanoparticle formation at high temperatures. The resultant composite materials are collected in either waste (12) or product (13) container.

The antimicrobial PNCs having small NPs (<5 nm) are prepared by using a double-syringe microwave-flow system (FIG. 1b) in seconds time. In a typical experiment, a commercial polymer (e.g. polyamide (nylon-6), polyester (polycaprolactone), polyurethane (TPU), cellulose acetate etc.) is dissolved in a suitable organic solvent (e.g. formic acid, DMF, DMAc, NMP, DMSO etc.) at room temperature. Similarly, a solution of a metal salt precursor is prepared by dissolving it in a solvent that does not act as a reducing agent at room temperature. It is important not to mix these two solutions at this stage since nuclei/seeds can be formed at room temperature. The system described in FIG. 1b and FIG. 2 is used to prepare polymer composites. Two peristaltic pumps (18) (or two syringe pumps (1)) are used to dispense the solutions into the reaction zone. The T-junction provides a mixing chamber just before the reaction zone and the fine-tuning of precursor concentration is performed in this chamber. The location of the T-junction is critical to prevent any likely undesired particle formation before the reaction starts. It is located just outside of the microwave zone. The precursor solutions are dispensed to the reactor zone at known concentrations and flow rates under constant microwave power to produce homogeneously distributed NPs with <5 nm in size in the polymer matrix. The effective microwave powers and flow rates to produce NPs are pre-determined by carrying the experiments without using polymers. This allows us to understand the effect of polymer to the particle size and its distribution. The produced NPs are instantly stabilized by the polymer functional groups. Homogeneous small NPs can not be produced by using a single-syringe set up or a traditional method.

The produced PNCs of polyamide and polyester were characterized by ultraviolet-visible spectroscopy (UV-vis), high-resolution transmission electron microscopy (HRTEM), and dynamic light scattering (DLS).

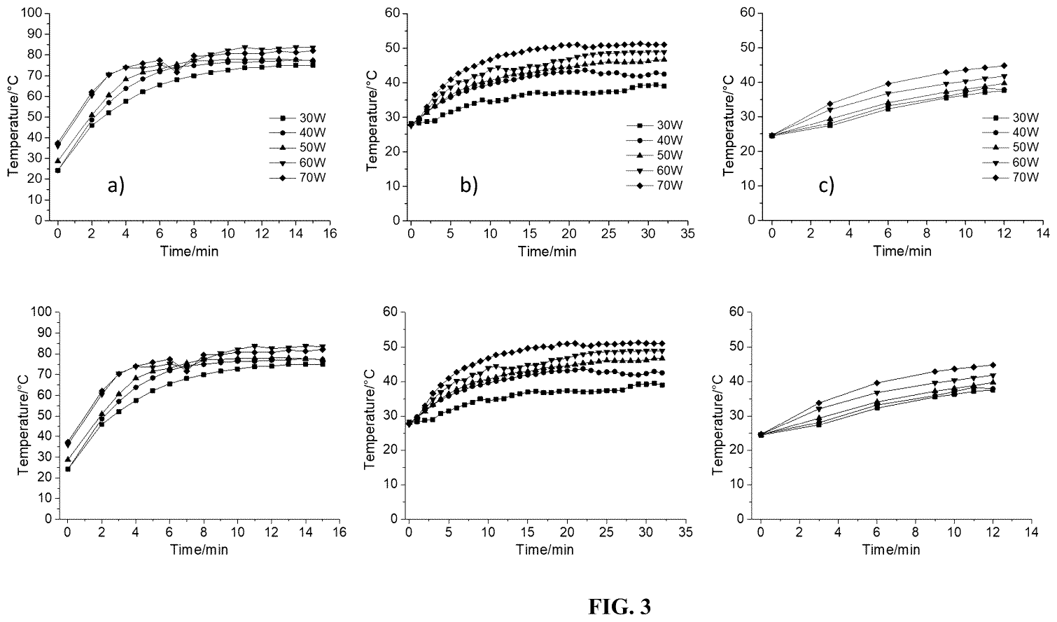

Dielectric loss is the propagation of energy through the movement of charges in an interchanging electromagnetic field as polarisation changes path. Thus, the dielectric loss is so critical while studying the microwave energy absorbing characteristic of a dielectric materials such as solvents (water, DMF and NMP). At first, the microwave absorption profile of water, DMF and NMP were evaluated under fluidic conditions. From the literature, water is known to have a higher dielectric loss value that DMF and NMP. For typical tests, varying microwave powers were applied under the flow rates of 1 mL/min for DMF and NMP, and 2 mL/min for water. Experimental findings suggested that water absorbed microwave energy more than DMF and NMP in a microwave-flow system (FIG. 3). In other words, the maximum reached temperature in the water was higher than DMF and NMP, although the flow rate is doubled.

Furthermore, the temperature variation in unit time for water was higher than DMF and NMP and the findings were consistent with the dielectric loss values. The most important outcome of these experiments was observing the temperature of the solvents that reached at an almost constant temperature in a microwave-flow system after applying a certain period of microwave power. This may induce the formation of homogenous nanoparticles in the polymer matrix. Moreover, the small changes in the temperature of DMF and NMP by time showed the existence of unconsumed microwave power that could be utilized for the activation of polymer functional groups.

### EXAMPLES

### Polyamide (PA)/Silver (Ag) NP Composites

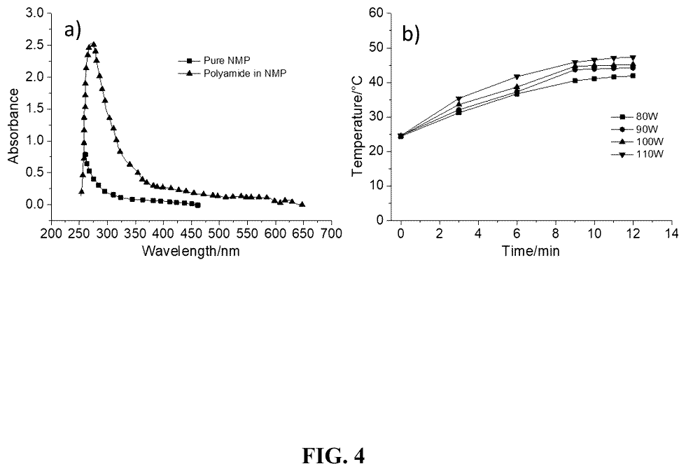

The composites are prepared in a single-syringe microwave-flow system without a reducing agent. Solubility of the polymer at room temperature is so critical for the process. Thus, the solubility of polyamide (Carl Roth-9620.2) was assessed in DMF, NMP and DMAc. Polyamide was found to be completely soluble in hot NMP. However, the solubility was low in NMP at room temperature, hence a solution of polyamide 1 g/300 mL was prepared at room temperature. In contrast, polyamide did not show enough solubility in DMF and DMAc at room temperature. The UV-vis spectra of pure NMP and polyamide are given in FIG. 4 a). After the selection of NMP as the solvent, the microwave energy absorbing characteristic of AgNO₃ dissolved in NMP was assessed further using 80, 90, 100, and 110 W microwave powers (FIG. 4 b)). The experiments were also carried out at 30, 40, 50, 60, and 70 W microwave powers using AgNO₃ solution (10 mg in 50 mL NMP), however, no significant change was observed (not shown here). Results revealed that microwave power and AgNO₃ had very limited effect on the temperature increase after the solvent temperature reached a constant value. The highest temperature recorded was around 45° C. for a reactor with a volume of 8 mL when 1 mL/min flow rate was used.

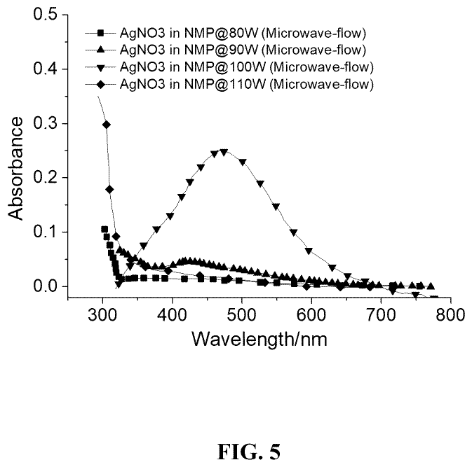

After exposing AgNO₃ solution to 80, 90, 100, and 110 W microwave powers in NMP at 1 mL/min flow rate, the color of solutions irradiated at 90 and 100 W turned into yellow. The UV-vis spectral analysis showed wavelength maxima at 425 nm and 470 nm for 90 and 100 W microwave powers, respectively (FIG. 5). These bands were in good agreement with the characteristic absorption band of the Ag NPs. No UV-vis absorption band was observed at 80 and 110 W microwave powers. In conclusion, it is the first time to be shown that silver nanoparticles can be produced in a microwave-powered fluidic system at low temperatures (˜45° C.) in NMP without using any reducing agent. The synthesis conditions were highly dependent on the microwave power. Large particles (˜80-100 nm) were obtained at 100 W while small particles (˜20-50 nm) were produced at 90 W. However, the high intensity of the UV absorption band suggested that the concentration of particles was high when 100 W microwave power was applied. Hence, the polymer composite formation experiments were carried out at 100 W microwave power. By doing so, it was aimed to understand the effect of polyamide to the particle size.

To prepare the polyamide (PA)/Ag NP composites, 50 mL solution of PA (1 g/300 mL) and AgNO₃ (10 mg) in NMP was prepared. Also, 50 mL solution of PA (1 g/300 mL) and AgNO₃ (5 mg) in NMP was prepared to evaluate the effect of precursor concentration on the size distribution and homogeneity of the produced particles in the polymer matrix. Three different experimental conditions i) microwave heating-flow, ii) microwave heating-batch and iii) conventional heating-batch were used to prepare the composites. Four different composites were prepared following the above-mentioned procedures.
Composite 1. Conventional-Batch (10 mg AgNO₃+PA+NMP) at ca. 45° C.
Composite 2. Microwave-Batch (10 mg AgNO₃+PA+NMP) at ca. 45° C.
Composite 3. Microwave-FLOW (10 mg AgNO₃+PA+NMP) at 100 W
Composite 4. Microwave-FLOW (5 mg AgNO₃+PA+NMP) at 100 W

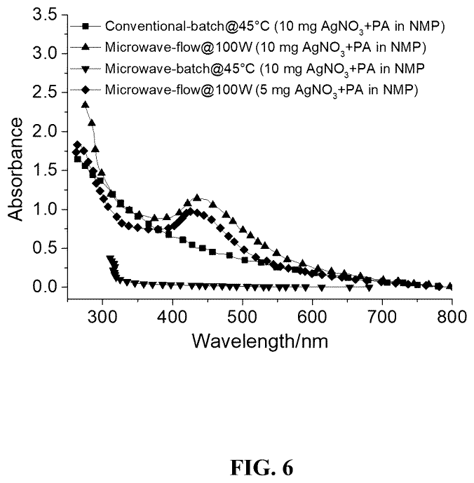

The UV-vis spectra of the composites in NMP are shown in FIG. 6. The UV-vis absorption bands located at ca. 438 nm and 425 nm correspond to the composite 4 and the composite 3, respectively. The blue-shift (compared to 470 nm for AgNO₃ solution exposed to 100 W microwave power) in the wavelength max (λₘₐₓ) of the composite 4 and 3 suggests that the Ag NPs produced in the presence of polyamide matrix are small in size. These findings reveal that the polymer matrix probably acts as a stabilizer and has an effect on controlling the particle size. Furthermore, the blue-shift observed for the Ag NPs produced by using 5 mg of AgNO₃ (compared to 10 mg AgNO₃) suggests the critical role of the precursor concentration on the particle size in a microwave-fluidic system. In contrast, this was not the case in microwave-batch and conventional-batch systems. In other words, no particle formation was observed in these experimental conditions.

In conclusion, we have for the first time shown that silver nanoparticles can be produced in the presence of polyamide matrix in a microwave-powered fluidic system at low temperatures (˜45° C.) in NMP without using any reducing agent. It was also shown that the size of produced nanoparticles in the polymetem matrix (herein polyamide) can be manipulated by changing the concentration of the precursor silver salt, silver nitrate (AgNO₃).

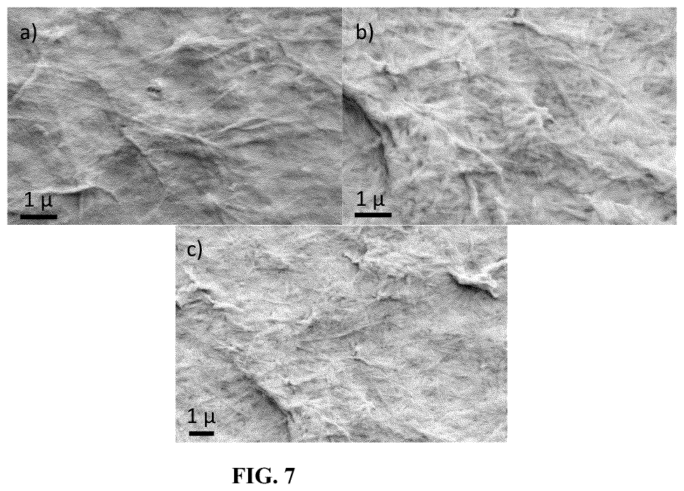

Complementary SEM images for the as-received PA, the Composite 1 and the Composite 2 are shown in FIG. 7. Consistent with the UV-vis analyses, no particle was visualized in SEM images of the Composite 1 and the Composite 2, further confirming the superiority of the microwave-flow system over the microwave-batch and the conventional-batch systems.

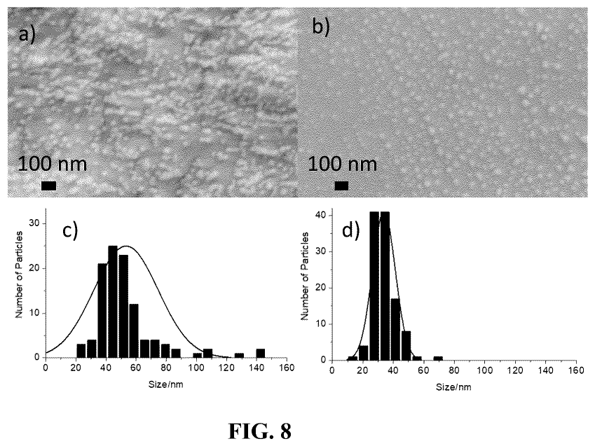

On the other hand, SEM images of the Composite 3 and the Composite 4 showed homogeneously distributed Ag NPs (FIG. 8). The calculated average size of particles was 33.8±7.5 nm in the Composite 4 (114 particles) compared to 53.3±21.3 nm for the Composite 3. Overall, SEM images showed that the precursor concentration was a highly effective parameter to manipulate size of the particles and their distribution in the polymer matrix. It is also worth mentioning that the NP size was ˜80-100 nm when no polymer was used. These findings clearly prove that the polymer functional groups serve as nucleating sites and controls the size of produced NPs in the polymer matrix by pointing out the novelty of the process.

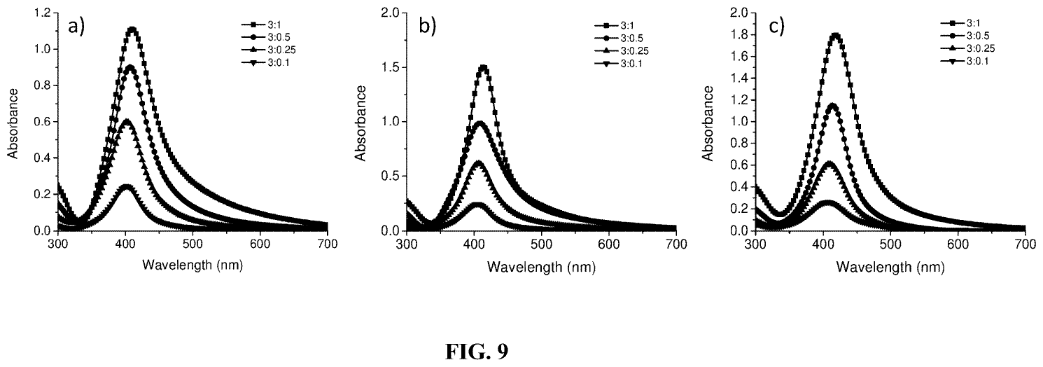

FIG. 9 shows UV-vis spectra of polyamide (PA)/silver (Ag) NP composites prepared by using varying PA concentrations. A glance at this figure revealed that increasing the amount of PA in formic acid led to a blue-shift in Amax of synthesized AgNPs.

### Polyamide (PA)/Silver (Ag) NP Composites With a Reducing Agent

The composites are prepared in a double-syringe microwave-flow manufacturing system with a reducing agent, NaBH₄. Silver nitrate (AgNO₃, ≥99.8%), sodium borohydride (NaBH₄, ≥99%), and nylon 6 ((C₆H₁₁NO)ₙ, 99%) are utilized as precursors and formic acid (98-100%) is used as the only solvent. In a typical procedure, PA (nylon 6) is dissolved in formic acid to a solution of 4 mg/mL and then solid AgNO₃ is added to this solution to obtain PA/AgNO₃ mixture containing 0.001 M of AgNO₃. In another vessel, 0.002 M NaBH₄ solution is prepared in formic acid. Solutions are transferred to two different syringes connected to the microwave-flow manufacturing system. The system is fed by these solutions simultaneously at a flow rate of 0.1 mL/min and 3 mL/min for PA/AgNO₃ and NaBH₄, respectively under microwave power of 30 W. The prepared composite material is collected in the product container.

### Polycaprolactone (PCL)/Silver (Ag) NP Composites

The composites are prepared in a double-syringe microwave-flow manufacturing system using binary solvent without a reducing agent. In a typical procedure, PCL (Sigma Aldrich, 80000 M_{w}) is dissolved in DMF to a solution of 10 mg/mL. In another vessel, AgNO₃ is dissolved in DMSO at a concentration of 0.1 mg/mL. Solutions are transferred to two different syringes connected to the microwave-flow system. The system is fed by these solutions simultaneously at a flow rate of 0.5 mL/min under microwave power of 70 W. DMF is not used to prepare AgNO₃ solution since Ag NPs form in DMF at room temperature.

### Antimicrobial Tests of the Produced AgNPs/PA Composite Films

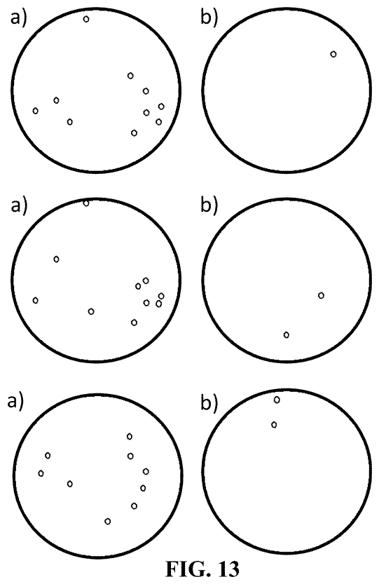

For the antimicrobial activity tests, the Japanese Industrial Standard (JIS) technique (JIS Z2801:2010) was utilized for evaluating the antibacterial impact of the AgNPs/PA. A single colony of gram-negative Escherichia coli was inoculated in a 5-mL Lysogeny broth (LB) and incubated at 37° C. for 24 h. This step was followed by dilution to adjust the number of bacteria to 1.5×10⁸ CFU/mL and the diluted sample was utilized for further tests. In this step, 12×12 mm control and AgNP/PA composite films were prepared for the test. The film was sterilized using Ultraviolet irradiation in a laminar flow hood, and 25 uL of culture medium containing bacteria was poured onto it. Then, the film was put in a Petri dish with the lid closed. After incubating at 37° C. for 24 h, the sample was put in 50-mL tubes and washed with 10 mL of phosphate buffered saline (PBS) for 5 minutes. Following this, 1 mL of the wash solution was pipetted into a test tube containing 9 ml of PBS, mixed well, and the dilution was repeated to prepare 5-fold serial dilutions. Then, 1 mL of the final diluted solution was spread in a Petri dish containing nutrient broth and incubated at 37° C. for 24 h. The Equation presented below was utilized for the calculation of the antibacterial rate. Antibacterial rate (%)=(Nr−Nc)/Nr Where Nr and Nc stand for a number of viable bacteria on free film and the number of viable bacteria on AgNP/PA films, respectively after incubation for 24 hours. The antibacterial rate calculated for AgNP/PA film on E. coli bacteria was calculated as 99.0119% which indicates the high antibacterial effect of this film on tested bacteria. As seen in FIG. 13, the number of colony forming units (CFU) in the Petri dishes reduced significantly due to the high effect of Ag/PA nanocomposite film on E. coli. The results are in agreement with the findings of Jo et al. [7]. This procedure was repeated for bacteria, P. aeruginosa and S. aureus.

### REFERENCES

[1] M. K. Bayazit, J. Yue, E. Cao, A. Gavriilidis, J. Tang, Controllable synthesis of gold nanoparticles in aqueous solution by microwave assisted flow chemistry, ACS Sustainable Chemistry & Engineering, 4, (2016), 6435-6442.
[2] M. K. Bayazit, E. Cao, A. Gavriilidis, J. Tang, A microwave promoted continuous flow approach to self-assembled hierarchical hematite superstructures, Green Chemistry, 18, (2016), 3057-3065.
[3] C. C. Lau, M. K. Bayazit, F. J. T. Reardon, J. Tang, Microwave intensified synthesis: Batch and Flow Chemistry, The Chemical Record, 19, (2018), 172-187.
[4] S. Sarkar, E. Guibal, F. Quignard, A. K. SenGupta, Polymer-supported metals and metal oxide nanoparticles: synthesis, characterization, and applications, J Nanopart Res 14 (2012) 715.

What is claimed is:

1. A method for production of an antimicrobial polymer nanocomposite structure comprising the steps of:
a) dissolving a polymer in an aqueous or organic solvent at room temperature;
b) preparing a solution of a metal salt precursor by dissolving the metal salt precursor in a solvent that does not act as a reducing agent at ambient conditions and is miscible with the aqueous or organic solvent the polymer is dissolved in;
c) transferring the solutions prepared in steps a and b into a coiled-flow reactor by two syringes controlled by syringe pumps or by peristaltic pumps to obtain pre-defined reaction concentrations for scalable productions or by a single syringe if no reducing agent is used at room temperature in the solvents from steps a and b by closing one valve;
d) pre-mixing the solutions prepared in steps a and b in a three-way connector for homogeneous mixture formation before reaching the coiled-flow reactor;
e) dispensing the solutions prepared in steps a and b to the coiled-flow reactor at known concentrations and flow rates under constant microwave power; and
f) producing homogeneously distributed nanoparticles (NPS) with <5 nm in size in a polymer matrix under controlled pressure provided by a pressure regulator and pressurized gas.

2. The method according to claim 1, wherein the polymer is a polyamide, a polyester, a polyurethane or a cellulose acetate.

3. The method according to claim 2, wherein the polyamide is nylon-6.

4. The method according to claim 2, wherein the polyester is polycaprolactone.

5. The method according to claim 2, wherein the polyurethane is thermoplastic polyurethane.

6. The method according to claim 1, wherein the metal salt precursor comprises inorganic/organic silver, inorganic/organic copper, inorganic/organic zinc, or inorganic/organic iron.

7. The method according to claim 1, wherein the organic solvent is DMF, NMP, DMAc, DMSO or formic acid.

8. An antimicrobial polymer nanocomposite structure comprising inorganic nanoparticles dispersed in a polymer matrix having particle size less than 5 nm produced according the method of claim 1.

9. The method according to claim 6, wherein the metal salt precursor comprises inorganic/organic silver.

10. The method according to claim 9, wherein the inorganic/organic silver is AgNO₃, CH₃COOAg.

11. The method according to claim 6, wherein the metal salt precursor comprises inorganic/organic copper.

12. The method according to claim 11, wherein the inorganic/organic copper is Cu(NO₃)₂, CuCO₂CH₃.

13. The method according to claim 6, wherein the metal salt precursor comprises inorganic/organic zinc.

14. The method according to claim 13, wherein the inorganic/organic zinc is Zn(NO₃)₂, Zn(CH₃COO)₂.

15. The method according to claim 6, wherein the metal salt precursor comprises inorganic/organic iron.

16. The method according to claim 15, wherein the inorganic/organic iron is Fe(NO₃)₃, Fe(CO₂CH₃)₂.
